(19) United States
(12) Patent Application Publication
(10) Pub. No.: US 2013/0151199 A1
(43) Pub. Date: Jun. 13, 2013

(54) SYSTEMS AND METHODS FOR USE IN MONITORING AN INDUSTRIAL FACILITY

(71) Applicant: Steven Ross Hadley, Minden, NV (US)

(72) Inventor: Steven Ross Hadley, Minden, NV (US)

(21) Appl. No.: 13/313,568

(22) Filed: Dec. 7, 2011

(51) Int. Cl. G06F 15/00

(52) U.S. Cl. 702/183

(57) ABSTRACT

A monitoring system for use in an industrial facility is provided. The monitoring system includes at least one sensor configured to detect at least one operating parameter of the industrial facility. A computing device is coupled to the sensor and includes a communication interface that is configured to receive a plurality of signals that are each representative of the operating parameter. A processor is coupled to the communication interface and programmed to calculate a moving average, such as an adaptive moving average, of each signal to enable the identification of at least one fault within the industrial facility. Calculating the moving average of each signal is an iterative calculation based at least in part by calculating a current signal average estimate for a first signal.

### BACKGROUND OF THE INVENTION

The field of the invention relates generally to industrial facilities and more particularly, to systems and methods for use in monitoring power industrial facilities.

At least some known industrial facilities, such as power generation systems and/or process plant systems, include one or more components that may become damaged and/or that wear over time. For example, known power generation systems include components such as, bearings, gears, and/or shafts that wear over time, resulting in a fault. Faults in the component may include a crack within the component, a disconnection of electrical wires, and/or a misalignment of the component. Continued operation with a worn component may cause additional damage to other components and/or may lead to a premature failure of the component and/or associated system.

To detect component damage within machines, the operation of at least some known machines is maintained with a monitoring system. For example, at least some known monitoring systems use sensors to perform proximity measurements of at least some components of the system. Proximity measurements can be performed using, for example, eddy current sensors, magnetic pickup sensors, microwave sensors, thermocouples, pressure sensors, and/or capacitive sensors. The data detected by such sensors are transmitted to a display device and/or a computing device by at least one signal that is representative of the data. The data may then be analyzed within the display device and/or computing device and an output representative of the analysis is presented to a user such that the user is enabled to identify any faults within the power generation system. More specifically, the data may include measurements and/or various variables that are summed together and/or collated to determine if there is a fault within the power generation system.

However, in such monitoring systems, the data that is received by the display device and/or computing device may not be accurate. More specifically, the signal representative of the data may be disrupted during transmission from the sensor to the display device and/or to the computing device. Accordingly, the data may be corrupted and any resulting output, such as a graphical representation of the data, may be inaccurate and the user may receive a false alarm of a fault within the power generation system.

### BRIEF DESCRIPTION OF THE INVENTION

In one embodiment, a monitoring system for use in an industrial facility is provided. The monitoring system includes at least one sensor configured to detect at least one operating parameter of the industrial facility. A computing device is coupled to the sensor and includes a communication interface that is configured to receive a plurality of signals that are each representative of the operating parameter. A processor is coupled to the communication interface and programmed to calculate a moving average of each signal to enable the identification of at least one fault within the industrial facility. Calculating the moving average of each signal is an iterative calculation based at least in part by calculating a current signal average estimate for a first signal.

In another embodiment, an industrial facility is provided. The industrial facility includes at least one machine that includes at least one component. A monitoring system is coupled to the component. The monitoring system includes at least one sensor configured to detect at least one operating parameter of the component. A computing device is coupled to the sensor and includes a communication interface that is configured to receive a plurality of signals that are each representative of the operating parameter. A processor is coupled to the communication interface and programmed to calculate a moving average of each signal to enable the identification of at least one fault within the industrial facility. Calculating the moving average of each signal is an iterative calculation based at least in part by calculating a current signal average estimate for a first signal.

In yet another embodiment, a method of monitoring an industrial facility is provided. At least one operating parameter of the industrial facility is detected. A plurality of signals representative of the operating parameter is transmitted to a computing device. The signals are received via a communication interface. A moving average of each signal is calculated, via a processor, wherein calculating the moving average of each signal is an iterative calculation. Calculating the moving average of each signal includes calculating a current signal average estimate for a first signal.

### BRIEF DESCRIPTION OF THE DRAWINGS

FIG. 1 is a block diagram of an exemplary industrial facility; and

FIG. 2 is a block diagram of an exemplary monitoring system that may be used with the industrial facility shown in FIG. 1.

### DETAILED DESCRIPTION OF THE INVENTION

The exemplary systems and methods described herein provide a monitoring system for use with an industrial facility that is able to provide a substantially accurate output of data representative of any faults within the industrial facility. The monitoring system described herein includes at least one sensor configured to detect at least one operating parameter of the industrial facility. A computing device is coupled to the sensor and includes a communication interface that is configured to receive a plurality of signals that are each representative of the operating parameter. A processor is coupled to the communication interface and programmed to calculate a moving average, such as an adaptive moving average, of each signal to enable the identification of at least one fault within the industrial facility. Calculating the moving average of each signal is an iterative calculation based at least in part by calculating a current signal average estimate for a first signal. By calculating a moving average for each signal, the resulting output, such as a graphical representation of the data, will likely be accurate even if any of the signals are corrupt. Accordingly, false findings and/or false alarms with regard to faults within the industrial facility may be prevented.

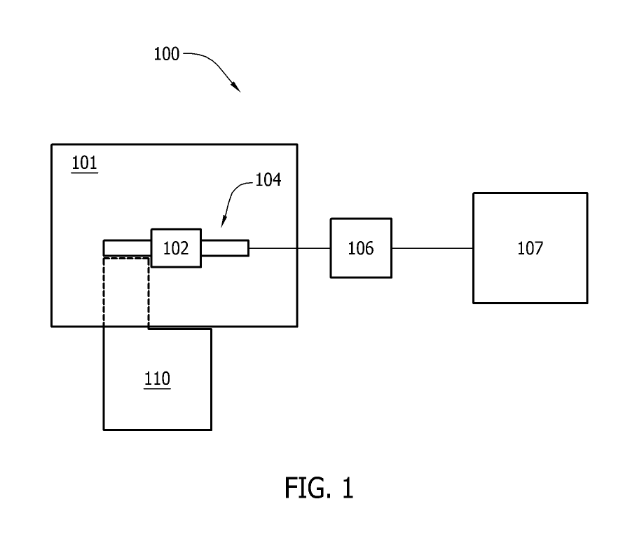

FIG. 1 illustrates an exemplary industrial facility 100. More specifically, in the exemplary embodiment, industrial facility is a power generation system 100. While the exemplary embodiment includes a power generation system, the present invention is not limited to a power generation system, and one of ordinary skill in the art will appreciate that the current invention may be used in connection with other types of industrial facilities, such as, for example, a process plant system.

Power generation system 100 includes a machine 101. In the exemplary embodiment, machine 101 is a variable speed machine, such as a wind turbine, a hydroelectric steam turbine, a gas turbine, and/or any other machine that operates with a variable speed. Alternatively, machine 101 may be a synchronous speed machine. In the exemplary embodiment, machine 101 includes at least one component, such as a rotor 102 and a drive shaft 104. Moreover, in the exemplary embodiment, rotor 102 rotates drive shaft 104 that is coupled to a generator 106. In the exemplary embodiment, generator 106 is a doubly-fed induction generator that is coupled to a power distribution system 107. Alternatively, generator 106 may be any other type of generator that is coupled to any electrical system that enables power generation system 100 to function as described herein.

Power generation system 100 also includes a monitoring system 110, wherein a portion of monitoring system 110 is positioned proximate to drive shaft 104. In the exemplary embodiment, monitoring system 110 measures at least one operating parameter within drive shaft 104. Alternatively, monitoring system 110 may measure various other parameters of any other component within power generation system 100.

During operation, machine 101 generates mechanical rotational energy via rotor 102 and drives generator 106. Generator 106 supplies electrical power to power distribution system 107. Moreover, in the exemplary embodiment, because of wear, damage, or vibration, for example, one or more components may have at least one fault (not shown), such as a crack within drift shaft 104. As described in more detail below, monitoring system 110 measures at least one operating parameter of drive shaft 104 to obtain data for drive shaft 104 and presents an output, such as a graphical and/or textual representation of the data to a user.

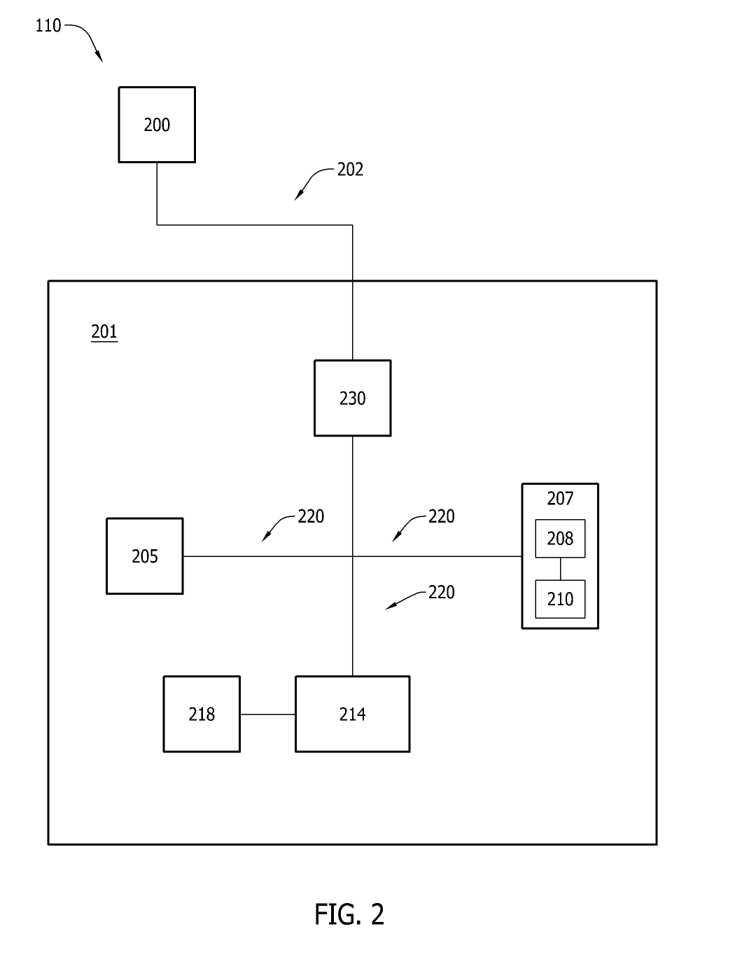

FIG. 2 is a block diagram of monitoring system 110. In the exemplary embodiment, monitoring system 110 includes at least one sensor 200 that is positioned proximate to drive shaft 104 (shown in FIG. 1). In the exemplary embodiment, sensor 200 is configured to measure at least one operating parameter of drive shaft 104, such as measuring and/or monitoring a distance between shaft 104 and sensor 200 to detect at least one fault, such as a crack within drive shaft 104 and/or a misalignment of drive shaft 104. More specifically, in the exemplary embodiment, sensor 200 is configured to use one or more microwave signals to measure a proximity, such as a frequency, static and/or vibration proximity, of drive shaft 104 with respect to sensor 200. As used herein, the term “microwave” refers to a signal or a component that receives and/or transmits signals having frequencies between about 300 Megahertz (MHz) and to about 300 Gigahertz (GHz). Alternatively, sensor 200 may be any other sensor or transducer that is able to measure operating parameters within power generation system 100 (shown in FIG. 1) and that enables power generation system 100 and/or monitoring system 110 to function as described herein.

A computing device 201 is coupled to sensor 200 via a data conduit 202. Alternatively, computing device 201 may be wirelessly coupled to sensor 200. In the exemplary embodiment, conduit 202 is an electrical conductor and enables the connection between computing device 201 and sensor 200. Alternatively, other connections may be available between computing device 201 and sensor 200, including a low-level serial data connection, such as Recommended Standard (RS) 232 or RS-485, a high-level serial data connection, such as Universal Serial Bus (USB) or Institute of Electrical and Electronics Engineers (IEEE®) 1394, a parallel data connection, such as IEEE® 1284 or IEEE® 488, a short-range wireless communication channel such as BLUETOOTH®, and/or a private (e.g., inaccessible outside power generation system) network connection, whether wired or wireless. IEEE is a registered trademark of the Institute of Electrical and Electronics Engineers, Inc., of New York, N.Y. BLUETOOTH is a registered trademark of Bluetooth SIG, Inc. of Kirkland, Wash.

In the exemplary embodiment, computing device 201 processes and/or analyzes data received from sensor 200. More specifically, in the exemplary embodiment, computing device processes and/or analyzes a plurality of signals that are each representative of at least one operating parameter of drive shaft 104 received from sensor 200. Computing device 201 also presents the data to a user, such as an operator of system 100. Alternatively, monitoring system 110 may include two separate computing devices that are coupled to each other, wherein one computing device may process and/or analyze the data and the other computing device may provide a display of the data to the user.

In the exemplary embodiment, computing device 201 includes a user interface 205 that receives at least one input from a user, such as an operator of power generation system 100. In the exemplary embodiment, user interface 205 includes a keyboard 206 that enables a user to input pertinent information. Alternatively, user interface 205 may include, for example, a pointing device, a mouse, a stylus, a touch sensitive panel (e.g., a touch pad or a touch screen), a gyroscope, an accelerometer, a position detector, and/or an audio input interface (e.g., including a microphone).

Moreover, in the exemplary embodiment, computing device 201 includes a presentation interface 207 that presents information, such as input events and/or validation results, to the user. In the exemplary embodiment, presentation interface 207 includes a display adapter 208 that is coupled to at least one display device 210. More specifically, in the exemplary embodiment, display device 210 is a visual display device, such as a cathode ray tube (CRT), a liquid crystal display (LCD), an organic LED (OLED) display, and/or an “electronic ink” display. Alternatively, presentation interface 207 may include an audio output device (e.g., an audio adapter and/or a speaker) and/or a printer.

Computing device 201 also includes a processor 214 and a memory device 218. In the exemplary embodiment, processor 214 is coupled to user interface 205, presentation interface 207, and to memory device 218 via a system bus 220. In the exemplary embodiment, processor 214 communicates with the user, such as by prompting the user via presentation interface 207 and/or by receiving user inputs via user interface 205. Moreover, in the exemplary embodiment, processor 214 is programmed by encoding an operation using one or more executable instructions and providing the executable instructions in memory device 218.

In the exemplary embodiment, processor 214 is programmed to calculate a moving average of each signal received from sensor 200. More specifically, processor 214 is programmed to calculate an adaptive moving average of each signal that is received from sensor 200. The calculation is an iterative calculation based at least in part by calculating a current signal average estimate, Yᵢ, for each signal that is received from sensor 200. The current signal average estimate, Yᵢ, is based at least in part on a temporal weight factor, αᵢ, a current signal value, Sᵢ, indicated by the current signal being analyzed (i.e., the true value of the current signal received from sensor 200, including any process noise), and a previous signal average estimate, Yᵢ−1, that was calculated for a preceding signal that was received from sensor 200 directly prior to receiving the current signal, as shown in Equation 1.

Yᵢ=αᵢ(Sᵢ)+(1−αᵢ)(Yᵢ−1) (Eq. 1)

More specifically, Equation 1 is a non-linear adaptive version of an exponential moving average. By using Equation 1 in the exemplary embodiment, processor 214 is programmed to calculate the current signal average estimate, Yᵢ, at least in part by calculating a product of the temporal weight factor, αᵢ, and the current signal value, Sᵢ, indicated by the current signal being analyzed. In Equation 1, the temporal weight factor, αᵢ, is a function of a data window statistic, wherein the window refers to two or more consecutive trailing data values in a time series that are used to derive the temporal weight factor, αᵢ. As such, the temporal weight factor, αᵢ, is a signal averaging weight for a time period, i, that changes as a function of a window statistic. In the exemplary embodiment, the temporal weight factor, αᵢ, is a fluctuating numeric value of between about 0 and about 1. More specifically, the window statistic used to compute the temporal weight factor, αᵢ, can be any expression that results in an increase in αᵢ coinciding with an increase in the signal trend. An example of an applicable window statistic is the percentage of window points that are greater than a moving average mean plus two standard deviations for a normal operating data reference. The processor is programmed to calculate the temporal weight factor, αᵢ, value from a data window statistic via a transform function that converts the data window statistic to a numeric value from 0 to 1 for a time period. For example, the temporal weight factor, αᵢ, value may be derived from the data window statistic by using a monotonically increasing functional transform, such as a sigmoid function or power function, to convert the data window statistic to a numeric values of between about 0 and about 1. Alternatively, the temporal weight factor, αᵢ, may be a constant numeric value between approximately 0 and 1.

Moreover, in calculating the current signal average estimate, Yᵢ, for the current signal, processor 214 is programmed to calculate at least a product of a complement temporal weight factor, 1−αᵢ, and the previous signal average estimate, Yᵢ−1, that was calculated for the preceding signal that was received from sensor 200 directly prior to receiving the current signal. Processor 214 is also programmed to calculate the sum of the product of the temporal weight factor, αᵢ, and the current signal value, Sᵢ, indicated by the current signal with the product of the complement temporal weight factor, 1−αᵢ, and the previous signal average estimate, Yᵢ−1.

Moreover, in the exemplary embodiment, processor 214 is programmed with threshold values for a current signal average estimate, Yᵢ, for a plurality of signals that are representative of normal operating parameters. For example, processor 214 may also be programmed to generate an output, such as a graphical representation, of the data of normal operating parameters for a component, such as a drive shaft and processor 214 calculate a mean and/or a standard deviation of the data. The threshold values may then be calculated by considering the mean and/or standard deviation of a moving average output, Y, computed from a normal operation data set. Moreover, processor 214 may be programmed to compare the current signal average estimate, Yᵢ, that is obtained for each of the signals received by sensor 200 with the threshold values.

The term “processor” refers generally to any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term “processor.”

In the exemplary embodiment, memory device 218 includes one or more devices that enable information, such as executable instructions and/or other data, to be stored and retrieved. Moreover, in the exemplary embodiment, memory device 218 includes one or more computer readable media, such as, without limitation, dynamic random access memory (DRAM), static random access memory (SRAM), a solid state disk, and/or a hard disk. In the exemplary embodiment, memory device 218 stores, without limitation, application source code, application object code, configuration data, additional input events, application states, assertion statements, validation results, and/or any other type of data. More specifically, in the exemplary embodiment, memory device 218 stores input data received by the user via user interface 205 and/or information received from other components of monitoring system 110, such as sensor 200, and/or power generation system 100.

Moreover, in the exemplary embodiment, computing device 201 includes a communication interface 230 that is coupled to processor 214 via system bus 220. Further, in the exemplary embodiment, communication interface 230 is coupled to sensor 200 via conduit 202. Communication interface 230 receives a plurality of signals representative of at least one operating parameter of at least one component, such as drive shaft 104, within the power generation system 100 from sensor 200.

During operation, because of wear, damage, or vibration, for example, one or more components may have at least one fault (not shown), such as a crack within drive shaft 104. Prior to monitoring and/or testing drive shaft 104, a normal drive shaft having no defects may be monitored and/or tested to determine a standard or reference data set. For example, a data set taken during normal operations may be used to compute reference statistics, mean and standard deviation, for the moving average, Y. These statistics may then be used for alarm threshold calculations and in computation of the temporal weight factor, αᵢ.

When standard or reference statistics have been determined, monitoring system 110 may then measure at least one operating parameter for drive shaft 104 to obtain data for drive shaft 104 for presenting to a user, such as an operator of power generation system 100. More specifically, in the exemplary embodiment, sensor 200 measures at least one operating parameter of drive shaft 104, such as measuring and/or monitoring a distance between shaft 104 and sensor 200 in order to detect at least one fault, such as a crack within drive shaft 104 and/or a misalignment of drive shaft 104. More specifically, in the exemplary embodiment, sensor 200 uses one or more microwave signals to measure a proximity, such as a frequency, static and/or vibration proximity, of drive shaft 104 with respect to sensor 200.

In the exemplary embodiment, sensor 200 transmits to computing device 201 a plurality of signals, such as a first signal and a second signal, that are each representative of at least one operating parameter for drive shaft 104. In the exemplary embodiment, the signals, such as the first and second signals, are each received by communication interface 230 incrementally. For example, the second signal is received by communication interface 230 prior to receiving the first signal. The signals are then transmitted to processor 214.

By using Equation 1, processor 214 then calculates a moving average for each signal that is received from sensor 200. For example, by using Equation 1, processor 214 calculates the current signal average estimate, Yᵢ, of the first signal at least in part by calculating a product of the temporal weight factor, αᵢ, and the current signal value, Sᵢ, indicated by the first signal. In calculating the current signal average estimate, Yᵢ, for the first signal, processor 214 calculates a product of the complement temporal weight factor, 1−αᵢ, and the previous signal average estimate, Yᵢ−1, that was calculated for the second signal that was received from sensor 200 directly prior to receiving the first signal. Moreover, processor 214 calculates the sum of the product of the temporal weight factor, αᵢ, and the current signal value, Sᵢ, indicated by the first signal with the product of the complement temporal weight factor, 1−αᵢ, and the previous signal average estimate, Yᵢ−1, for the second signal. The results of the calculations are then transmitted to presentation interface 207 such that the user may view the data. In the exemplary embodiment, an output, such as a graphical and/or textual representation is provided, via display device 210, to the user. By calculating a moving average for each signal, the resulting output, such as a graphical representation of the data, will likely be accurate even if any of the signals are corrupt.

In the exemplary embodiment, during processing of signals that are representative of operating parameters of drive shaft 104 that are within normal limits, the temporal weight factor, αᵢ, remains approximately at its minimum value since the corresponding window statistic is within its expected range of operation. Accordingly, the current signal average estimate, Yᵢ, that is obtained for each of the signals received are substantially similar and a substantially smooth output is presented to the user. However, when sensor 200 begins to detect the fault within drive shaft 104, the temporal weight factor, αᵢ, begins to increase. The increase of the temporal weight factor, αᵢ, results in a substantial rapid change of the current signal average estimate, Yᵢ, that is obtained for each of the signals. The resulting output that is presented to the user is a substantially erratic output such that the user may readily identify that drive shaft 104 has a fault.

Moreover, in the exemplary embodiment, processor 214 is programmed with threshold values of the current signal average estimate, Yᵢ, for signals that are representative of normal operational parameters. When sensor 200 begins to detect the fault within drive shaft 104, the values of the current signal average estimate, Yᵢ, that are obtained for each of the signals are compared with the threshold values. If the current signal average estimates, Yᵢ, that are obtained for each of the signals exceed the threshold values, processor 214 generates a visual output, such as a textual representation of an alarm and/or warning. Alternatively, processor 214 may generate an audio alarm and/or warning. The output is presented to the user via presentation interface 207. Accordingly, the user of monitoring system 110 may be able to accurately identify the fault within drive shaft 104. By comparing values of the current signal average estimate, Yᵢ, that are obtained for each of the signals with threshold values of the current signal average estimate, Yᵢ, for signals that are representative of normal operational parameters, false alarms may be prevented.

As compared to known systems and methods that are used to monitor the operation of industrial facilities, the exemplary systems and methods described herein provide a monitoring system for use with industrial facilities that is able to provide a substantially accurate output of data representative of any faults within the facility. The monitoring system described herein includes at least one sensor configured to detect at least one operating parameter of the industrial facility. A computing device is coupled to the sensor and includes a communication interface that is configured to receive a plurality of signals that are each representative of the operating parameter. A processor is coupled to the communication interface and programmed to calculate a moving average of each signal to enable the identification of at least one fault within the industrial facility. Calculating the moving average of each signal is an iterative calculation based at least in part by calculating a current signal average estimate for a first signal. By calculating a moving average for each signal, the resulting output, such as a graphical representation of the data, will likely be accurate even if any of the signals are corrupt. Accordingly, false findings and/or false alarms with regard to faults within the industrial facility may be prevented.

A technical effect of the systems and methods described herein includes at least one of: (a) detecting at least one operating parameter of an industrial facility; (b) transmitting a plurality of signals representative of at least one operating parameter to a computing device; (c) receiving, via a communication interface, a plurality of signals; and (d) calculating, via a processor, a moving average of each signal, wherein calculating the moving average of each signal is an iterative calculation that includes calculating a current signal average estimate for a first signal.

Exemplary embodiments of the systems and methods are described above in detail. The systems and methods are not limited to the specific embodiments described herein, but rather, components of the apparatus, systems and/or steps of the methods may be utilized independently and separately from other components and/or steps described herein. For example, the system may also be used in combination with other apparatus, systems, and methods, and is not limited to practice with only the system as described herein. Rather, the exemplary embodiment can be implemented and utilized in connection with many other applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A monitoring system for use in an industrial facility, said monitoring system comprising:
at least one sensor configured to detect at least one operating parameter of the industrial facility; and
a computing device coupled to said at least one sensor, said computing device comprising:
a communication interface configured to receive a plurality of signals that are each representative of the at least one operating parameter; and
a processor coupled to said communication interface and programmed to calculate a moving average of each signal to enable the identification of at least one fault within the industrial facility, wherein calculating the moving average of each signal is an iterative calculation based at least in part by calculating a current signal average estimate for a first signal.

2. A monitoring system in accordance with claim 1, wherein said processor is programmed to calculate the current signal average estimate based at least in part on a temporal weight factor, a current signal value indicated by the first signal, and a previous signal average estimate of a second signal received by said communication interface prior to receiving the first signal.

3. A monitoring system in accordance with claim 2, wherein said processor is programmed to calculate the current signal average estimate for the first signal at least in part by calculating a product of the temporal weight factor and the current signal value indicated by the first signal.

4. A monitoring system in accordance with claim 2, wherein said processor is programmed to calculate the current signal average estimate for the first signal at least in part by calculating a product of a complement temporal weight factor and the previous signal average estimate of the second signal received by said communication interface.

5. A monitoring system in accordance with claim 2, wherein said processor is programmed to calculate the current signal average estimate for the first signal by calculating a sum of a product of the temporal weight factor and the current signal value indicated by the first signal with a product of a complement temporal weight factor and the previous signal average estimate of the second signal.

6. A monitoring system in accordance with claim 2, wherein said processor is programmed to calculate the temporal weight factor from a data window statistic via a transform function that converts the data window statistic to a numeric value from about 0 to about 1 for a time period such that the temporal weight factor includes a fluctuating numeric value of between about 0 and about 1.

7. A monitoring system in accordance with claim 1, wherein said processor is programmed to calculate at least one threshold value of the current signal average estimate, said processor is further programmed to compare the at least one threshold value of the current signal average estimate with the current signal average estimate for the first signal.

8. An industrial facility comprising:
at least one machine comprising at least one component; and
a monitoring system coupled to said at least one component, said monitoring system comprising:
at least one sensor configured to detect at least one operating parameter of said at least one component; and
a computing device coupled to said at least one sensor, said computing device comprising:
a communication interface configured to receive a plurality of signals that are each representative of the at least one operating parameter; and
a processor coupled to said communication interface and programmed to calculate a moving average of each signal to enable the identification of at least one fault within said at least one component, wherein calculating the moving average of each signal is an iterative calculation based at least in part by calculating a current signal average estimate for a first signal.

9. An industrial facility in accordance with claim 1, wherein said processor is programmed to calculate the current signal average estimate based at least in part on a temporal weight factor, a current signal value indicated by the first signal, and a previous signal average estimate of a second signal received by said communication interface prior to receiving the first signal.

10. An industrial facility in accordance with claim 2, wherein said processor is programmed to calculate the current signal average estimate for the first signal at least in part by calculating a product of the temporal weight factor and the current signal value indicated by the first signal.

11. An industrial facility in accordance with claim 2, wherein said processor is programmed to calculate the current signal average estimate for the first signal at least in part by calculating a product of a complement temporal weight factor and the previous signal average estimate of the second signal received by said communication interface.

12. An industrial facility in accordance with claim 2, wherein said processor is programmed to calculate the current signal average estimate for the first signal by calculating a sum of a product of the temporal weight factor and the current signal value indicated by the first signal with a product of a complement temporal weight factor and the previous signal average estimate of the second signal.

13. An industrial facility in accordance with claim 2, wherein said processor is programmed to calculate the temporal weight factor from a data window statistic via a transform function that converts the data window statistic to a numeric value from about 0 to about 1 for a time period such that the temporal weight factor includes a fluctuating numeric value of between about 0 and about 1.

14. An industrial facility in accordance with claim 1, wherein said processor is programmed to calculate at least one threshold value of the current signal average estimate, said processor is further programmed to compare the at least one threshold value of the current signal average estimate with the current signal average estimate for the first signal.

15. A method of monitoring an industrial facility, said method comprising:
detecting at least one operating parameter of the industrial facility;
transmitting a plurality of signals representative of the at least one operating parameter to a computing device;
receiving, via a communication interface, the plurality of signals; and
calculating, via a processor, a moving average of each signal, wherein calculating the moving average of each signal is an iterative calculation, calculating the moving average of each signal further comprises calculating a current signal average estimate for a first signal.

16. A method in accordance with claim 15, wherein calculating a current signal average estimate for a first signal further comprises calculating a current signal average estimate for a first signal based at least in part on a temporal weight factor, a current signal value indicated by the first signal, and a previous signal average estimate of a second signal received by the communication interface prior to receiving the first signal.

17. A method in accordance with claim 16, wherein calculating a current signal average for a first signal further comprises calculating a product of the temporal weight factor and the current signal value indicated by the first signal.

18. A method in accordance with claim 16, wherein calculating a current signal average estimate for a first signal further comprises calculating a product of a complement temporal weight factor and the previous signal average estimate of the second signal received by the communication interface.

19. A method in accordance with claim 16, wherein calculating a current signal average estimate for a first signal further comprises calculating a sum of a product of the temporal weight factor and the current signal value indicated by the first signal with a product of a complement temporal weight factor and the previous signal average estimate of the second signal.

20. A monitoring system in accordance with claim 16, further comprising calculating the temporal weight factor from a data window statistic via a transform function that converts the data window statistic to a numeric value from about 0 to about 1 for a time period such that the temporal weight factor includes a fluctuating numeric value of between about 0 and about 1.
